(19) United States
(12) Patent Application Publication
(10) Pub. No.: US 2017/0202317 A1
(43) Pub. Date: Jul. 20, 2017

(54) AUTOMATIC SPRAY SYSTEM FOR SHOE SOLE ADHESIVE AND SPRAY METHOD THEREFOR

(71) Applicant: ORISOL ASIA LTD., Chang Hwa (CN)

(72) Inventors: Jakov MAKOVER, Maccabim (IL); Bar Cochva MARDIX, Tel Aviv (IL); Yaacov SADEH, Rechovot (IL); Chang-Chen YANG, Chang Hwa (CN); Chien-Yu HSU, Chang Hwa (CN)

(21) Appl. No.: 15/314,076

(22) PCT Filed: May 26, 2014
(86) PCT No.: PCT/CN2014/078413

§ 371 Date: Nov. 26, 2016

(51) Int. Cl. A43D 25/18; B05D 1/02; B05B 13/04; B05B 12/12; B05B 13/02; A43D 111/00; G01B 11/24

(52) U.S. Cl. CPC A43D 25/183; A43D 111/00; B05D 1/02; G01B 11/24; B05B 12/122; B05B 13/0221; B05B 13/0457

(57) ABSTRACT

Provided are an automatic spray system for a shoe sole adhesive and a spray method therefor, wherein a spray gun and a coating tool are provided at the end of a mechanical arm, enabled to be located in an adhesive spray path, and respectively arranged at the inner and outer sides of a contour side line of the top face of a shoe sole, and by cooperating with the scan information of the top face of the shoe sole and the position information of the shoe sole read by a computer, the adhesive spray region of the spray gun slightly exceeds the contour side line of the top face of the shoe sole and overlaps with a cementing region at the top face of the shoe sole such that a large part of the adhesive is sprayed onto the cementing region, and a small part of the adhesive exceeding the contour side line is blocked and adsorbed by the coating tool, whereby the technical effects of automatically and accurately cementing the shoe sole, preventing the adhesive from overflowing and staining the shoe sole appearance, increasing the bonding strength between the shoe sole and the vamp by uniformly coating the adhesive etc.

### BACKGROUND OF THE INVENTION

Field of the Invention

The present invention relates to an automatic spray system for a shoe sole adhesive and a spray method thereof, and more particularly to an automatic spray system for a shoe sole adhesive and a spray method thereof capable of automatically spraying adhesive to the inner side of the contour side line of the top surface of the shoe sole.

Related Prior Art

The adhesive application process of a shoe sole is the process of adhering the shoe sole to the vamp, as shown in FIG. 1, wherein the shoe sole 10 includes a top surface 101 and a bottom surface 102. The top surface 101 is formed with a peripheral contour line 11 for allowing the shoe sole to be glued to the vamp. The inner side of the peripheral contour line 11 of the shoe sole 10 is provided with a cementing area 12 in which the adhesive is applied to adhere the vamp to the shoe sole.

The adhesive application process is normally performed in such a manner that a user has to use a brush or a cloth soaked with adhesive to the cementing area 12. However, it is difficult for the manual adhesive application process to control the amount of adhesive application. When the amount of adhesive application is not enough, the vamp is very likely to fall off from the bottom surface 102 of the shoe sole 10. If too much adhesive is applied, the excessive adhesive will flow out of the peripheral contour line 11 of the shoe sole 10 when the vamp is pressed onto the shoe sole 10, adhesive dirty will be formed around the periphery of the shoe sole 10 to influence the aesthetic appearance of the shoes. The excessive adhesive has to be and can only be removed by manual cleaning, which not only requires extra process but also increases manufacturing cost. Besides, the adhesive itself solidified through volatilization of chemical substances, which will produce easily inhaled poisonous gas.

To overcome the above problem, some of the shoe manufacturers tried to replace the manual adhesive application with automatic adhesive spray system. It is to be noted that even the shoe soles are made by use of the same module, they may have contours. Machine vision can be used to measure the real contour of each shoe sole, so that the computer program can revise the spray path to overcome the contour-caused technical problem. However, the outflow rate of the spray gun is difficult to be controlled, so that it is hard to spray the adhesive precisely within the cementing area 12 of the shoe sole 10, in other words, the adhesive sprayed by the spray gun may still exceeds the cementing area 12, and the excessive glue caused problem remains unsolved.

The present invention has arisen to mitigate and/or obviate the afore-described disadvantages.

### SUMMARY

One objective of the present invention is to provide an automatic spray system for a shoe sole adhesive and a spray method thereof, wherein a spray gun and a coating tool are provided at the end of a mechanical arm, enabled to be located in an adhesive spray path, and respectively arranged at the inner and outer sides of a contour side line of the top face of a shoe sole, and by cooperating with the scan information of the top face of the shoe sole and the position information of the shoe sole read by a computer, the adhesive spray region of the spray gun slightly exceeds the contour side line of the top face of the shoe sole and overlaps with a cementing region at the top face of the shoe sole such that a large part of the adhesive is sprayed onto the cementing region, and a small part of the adhesive exceeding the contour side line is blocked and adsorbed by the coating tool, whereby the technical effects of automatically and accurately cementing the shoe sole, preventing the adhesive from overflowing and staining the shoe sole appearance, increasing the bonding strength between the shoe sole and the vamp by uniformly coating the adhesive etc.

To achieve the above objective, an automatic spray system for a shoe sole adhesive in accordance with the present invention is used to spray an adhesive onto a shoe sole, the shoe sole includes a bottom surface and a top surface, the top surface is concave and provided around a periphery thereof with a three dimensional contour side line which is higher than the top surface, an annular region of an inner surface of the contour side line extending downward from a top edge of the contour side line is defined as a coating area, and another annular region of an inner surface of the contour side line below the coating area is defined as an adhesive spray region, the automatic spray system comprises:

a conveyor including a starting end, a finishing end, and an adhesive spray section between the starting and finishing ends, the shoe sole is conveyed from the starting end toward the finishing end, and the conveyor is provided with a position sensor which detects and converts the position of the shoe sole on the conveyor into a position data;

a three dimensional scanner is disposed above the starting end of the conveyor to scan and convert the contour side line of the top surface of the shoe sole into a scan data;

a sprayer includes a mechanical arm, a connecting member, a spray gun and a coating tool, the mechanical arm is located at the adhesive spray section of the conveyor and includes a terminal end which is located above the adhesive spray section, the connecting member is connected to the terminal end of the mechanical arm, and includes two opposite ends, one end is formed with a first assembling portion, and another end is provided with a second assembling portion, the coating tool is assembled to the second assembling portion, the spray gun is disposed on the first assembling portion, and includes a spray nozzle which sprays towards a center of the coating tool, the spray region of the spray gun overlaps with the coating area and the adhesive spray region of the top surface of the shoe sole and slightly exceeds the contour side line, a coating portion of the coating tool comes into contact with the coating area of the top surface of the shoe sole and is tangent to the contour side line;

a computer is electrically connected to the position sensor of the conveyor, the three dimensional scanner and the mechanical arm of the sprayer, to receive the position data and the scan data, based on the received position data and scan data, the computer instructs the mechanical arm to drive the spray gun to move along an inner side of the contour side line of the top surface of the shoe sole to spray adhesive to the coating area and the adhesive spray region, meanwhile, the coating portion of the coating tool is driven to move along the coating area and absorbs the adhesive which exceeds the contour side line.

Preferably, the coating area is the annular region of the inner surface of the contour side line extending to 2-3 mm downward from the top edge of the contour side line, the coating tool is brushing device, and the coating portion is a brush or sponge.

A spray method for using the automatic spray system in accordance with the present invention comprises the following steps:

a, putting the shoe sole onto the conveyor and conveying it from the starting end to the finishing end;

b, scanning, by the three dimensional scanner, the contour side line of the top surface of the shoe sole, and outputting a scan data of the contour side line of the top surface of the shoe sole;

c, reading, by the computer, the scan data;

d, detecting, by the position sensor of the conveyor, the position of the shoe sole on the conveyor, and outputting a position data corresponding to the scan data obtained by the three dimensional scanner, while the three dimensional scanner is scanning;

e, reading, by the computer, the position data, and determining, based on the position data, whether or not to send the shoe sole to the adhesive spray section of the conveyor, if the shoe sole does not reach the adhesive spray section, repeating the previous step d to re-detect the position of the shoe sole;

f, determining, by the computer, that the shoe sole has been sent to the adhesive spray section of the conveyor, producing, by the computer, a movement path instruction for moving the mechanical arm, based on the position data and the scan data; and

g, driving, by the mechanical arm, the spray gun to move along the contour side line of the top surface of the shoe sole to spray the adhesive, and the coating portion of the coating tool comes into contact with the coating area of the top surface of the shoe sole and is tangent to the contour side line to block and absorb the adhesive exceeds the contour side line of the shoe sole, and the coating area is coated with the absorbed adhesive when the coating portion comes into the coating area.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is an illustrative view showing the contour line of a conventional shoe sole;

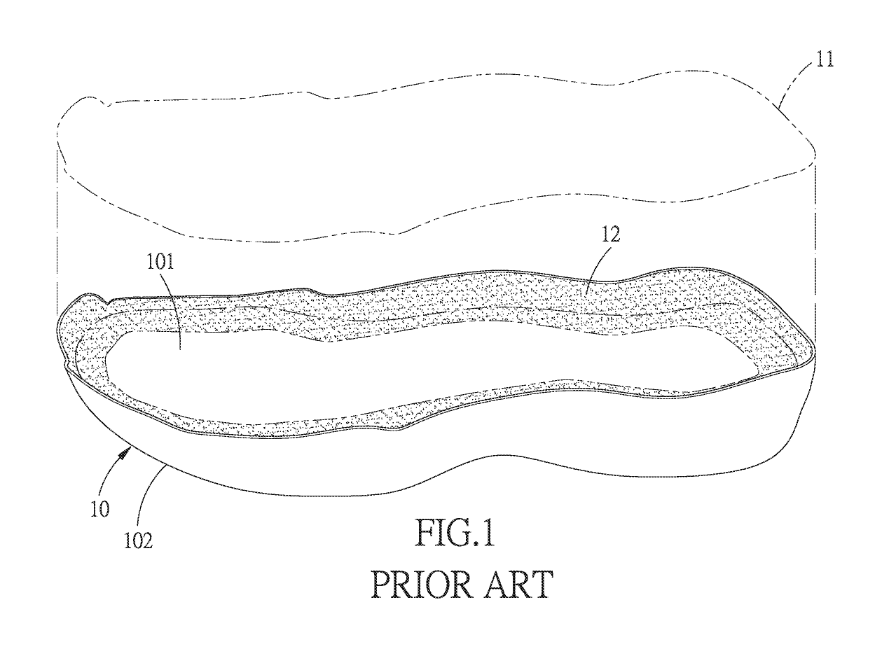

FIG. 2 is an illustrative view showing an automatic spray system for a shoe sole adhesive in accordance with the preferred embodiment of the present invention;

FIG. 3 shows that the automatic spray system in accordance with the present invention is used to spray adhesive onto a shoe sole;

FIG. 4 is a magnified view of a part of FIG. 3;

FIG. 5 is a cross sectional view showing that the automatic spray system in accordance with the present invention is used to spray adhesive onto a shoe sole;

FIG. 6 is another cross sectional view showing that the automatic spray system in accordance with the present invention is used to spray adhesive onto a shoe sole, wherein the coating portion is a brush;

FIG. 7 is another cross sectional view showing that the automatic spray system in accordance with the present invention is used to spray adhesive onto a shoe sole, wherein the coating portion is a sponge; and

FIG. 8 is a flow chart showing the steps of a spray method for using the automatic spray system for a shoe sole adhesive in accordance with the preferred embodiment of the present invention.

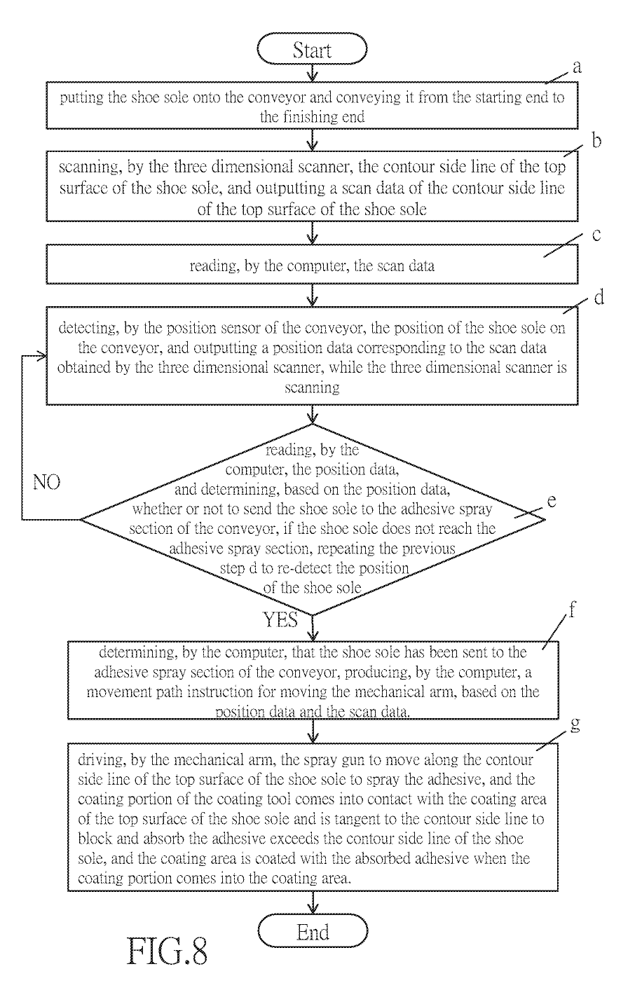

### DETAILED DESCRIPTION

The present invention will be clearer from the following description when viewed together with the accompanying drawings, which show, for purpose of illustrations only, the preferred embodiment in accordance with the present invention.

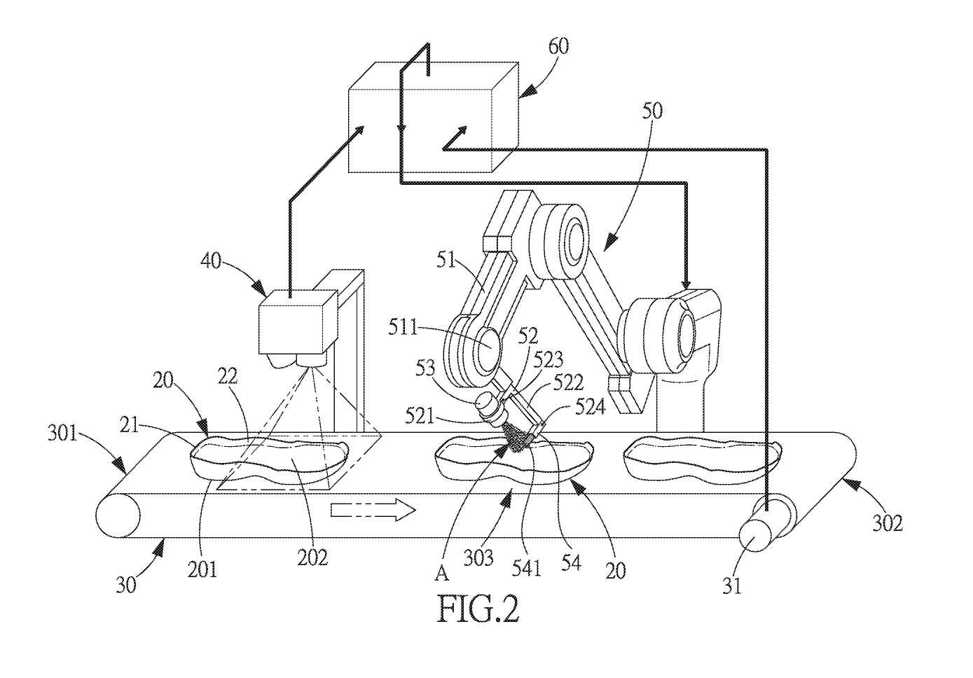

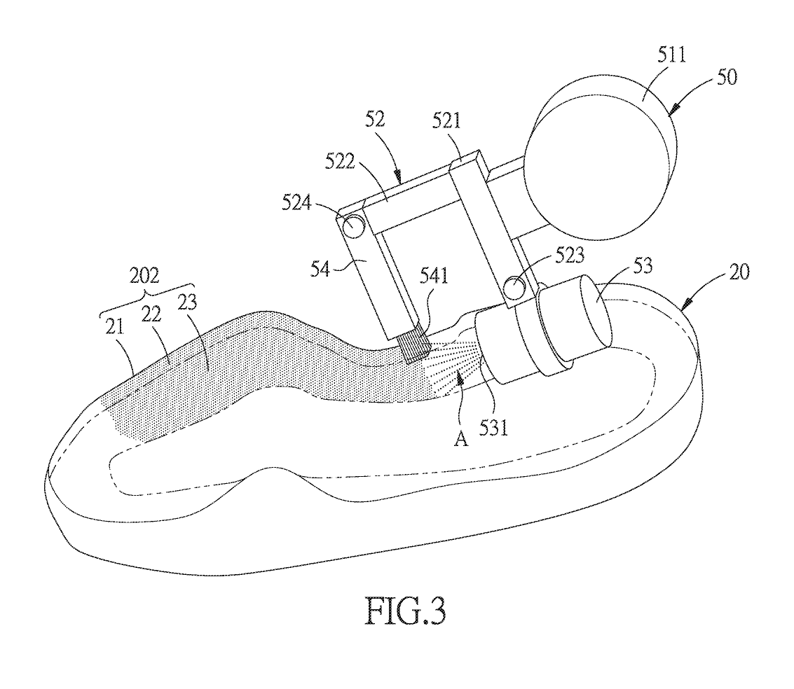

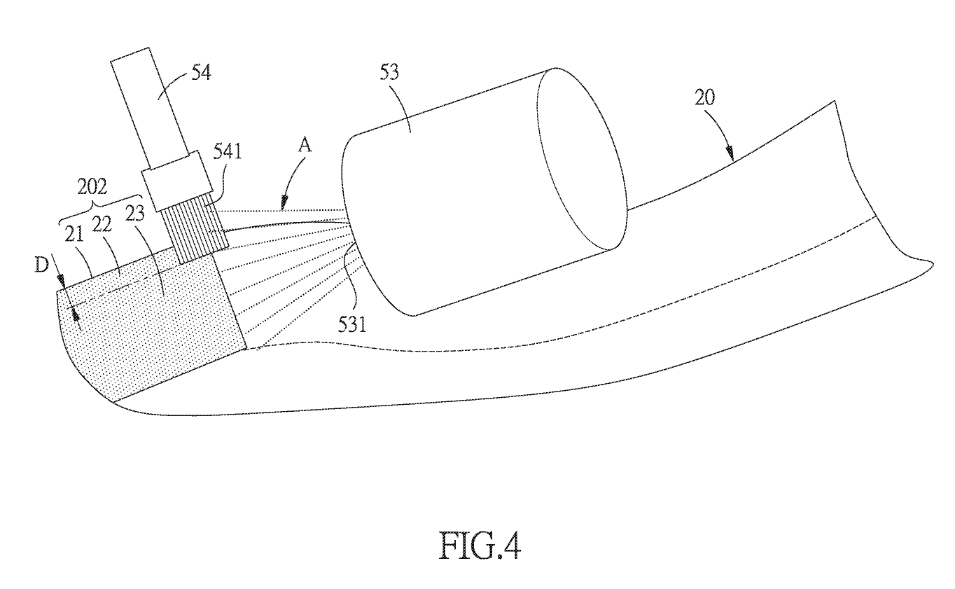

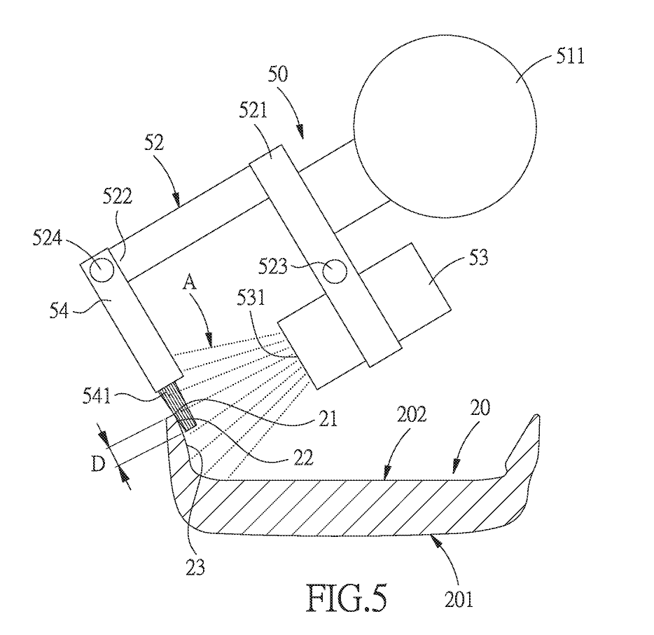

Referring to FIGS. 2-7, an automatic spray system for a shoe sole adhesive in accordance with the preferred embodiment of the present invention is used to spray an adhesive A onto a shoe sole 20. As shown in FIGS. 2 and 3, the shoe sole 20 includes a bottom surface 201 and a top surface 202. The top surface 202 is provided around the periphery thereof with a three dimensional contour side line 21 which is higher than the concave top surface 202. An annular region of an inner surface of the contour side line 21 extending a distance D (which is 2 to 3 mm) downward from the top edge of the contour side line 21 is defined as a coating area 22, and an annular region of an inner surface of the contour side line 21 below the coating area 22 is defined as an adhesive spray region 23. In this embodiment, the width of the adhesive spray region 23 can be adjusted according to actual needs. The automatic spray system comprises: a conveyor 30, a three dimensional scanner 40, a sprayer 50 and a computer 60.

The conveyor 30, as shown in FIG. 2, includes a starting end 301, a finishing end 302, and an adhesive spray section 303 between the starting and finishing ends 301, 302. The shoe sole 20 is conveyed from the starting end 301 toward the finishing end 302, and the conveyor 30 is provided with a position sensor 31 which can detect and convert the position of the shoe sole 20 on the conveyor 30 into a position data. In this embodiment, the position sensor 31 can be an angle reading sensor or a reading encoder.

The three dimensional scanner 40 is disposed above the starting end 301 of the conveyor 30 to scan and convert the contour side line 21 of the top surface 202 of the shoe sole 20 into scan data. In this embodiment, the three dimensional scanner 40 can be any known scanning device, such as the triangulation camera using a laser line projection, or the Gocator scanner produced by LMI.

The sprayer 50, as shown in FIGS. 2, 3, 5 and 6, includes a mechanical arm 51, a connecting member 52, a spray gun 53 and a coating tool 54. The mechanical arm 51 is located at the adhesive spray section 303 of the conveyor 30 and includes a terminal end 511 which is located above the adhesive spray section 303. The connecting member 52 is connected to the terminal end 511 of the mechanical arm 51, and includes two opposite ends, one end is formed with a first assembling portion 521, and the other end is provided with a second assembling portion 522. In this embodiment, the mechanical arm 51 is a multi-axis mechanical arm, and preferably five-axis mechanical arm.

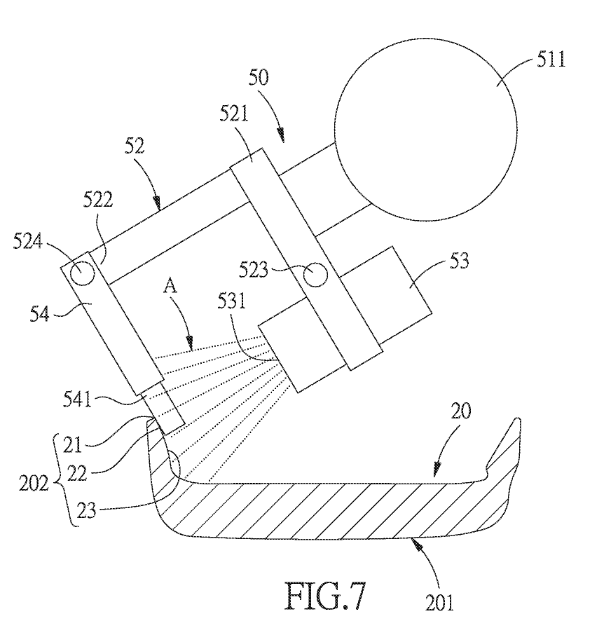

The spray gun 53 is disposed on the first assembling portion 521, and includes a spray nozzle 531 which sprays towards the center of the coating tool 54. The spray region of the spray gun 53 overlaps with the coating area 22 and the adhesive spray region 23 of the top surface 202 of the shoe sole 20 and slightly exceeds the contour side line 21. The coating tool 54 is disposed at the second assembling portion 522, and includes a coating portion 541 located opposite to the spray gun 53. The coating tool 54 blocks and absorbs the excessive adhesive A which exceeds the contour side line 21 of the shoe sole 20, and the absorbed adhesive A is collected and reapplied to the coating area 22 of the shoe sole 20. In this embodiment, the coating tool 54 can be a straight coating device with a straight handle, as shown in FIGS. 2-6, the coating tool 54 is a brushing device provided at the end with the coating portion 541 in the form of a brush, or as shown in FIG. 7, the coating portion 541 provided at the end of the coating tool 54 is in the form of a sponge to block and absorb sprayed adhesive A. The spray nozzle 531 of the spray gun 53 is preferably located toward the center of the coating portion 541. The coating portion 541 of the coating tool 54 comes into contact with the coating area 22 of the top surface 202 of the shoe sole 20 and is tangent to the contour side line 21.

In this embodiment, the first assembling portion 521 of the connecting member 52 of the sprayer 50 takes the form of a C-shaped structure for clamping the spray gun 53, and then an adjustment bolt 523 is used to adjust the clamping tightness. The second assembling portion 522 is in the form of a straight rod to be pivoted to the coating tool 54 by an adjustment bolt 54 which is capable of adjusting the position of the spray gun 53 with respect to the coating portion 541 of the coating tool 54, which makes sure that the spray nozzle 531 of the spray gun 53 sprays toward the coating portion 541. Besides, the coating portion 541 of the coating tool 54 is assembled the end of the second assembling portion 522 directly or indirectly via other connecting means.

The computer 60 is electrically connected to the position sensor 31 of the conveyor 30, the three dimensional scanner 40 and the mechanical arm 51 of the sprayer 50, to receive the position data and the scan data. Then, based on the received position data and scan data, the computer 60 instructs the mechanical arm 51 to drive the spray gun 53 to move along the inner side of the contour side line 21 of the top surface 202 of the shoe sole 20 to spray adhesive A to the coating area 22 and the adhesive spray region 23. Meanwhile, the coating portion 541 of the coating tool 54 is driven to move along the coating area 22 and absorbs the adhesive A which exceeds the contour side line 21.

What mentioned above are the structural relations of the main components of the present invention, for a better understanding of the spray method and effect of the preferred embodiment, reference should be made to the following description.

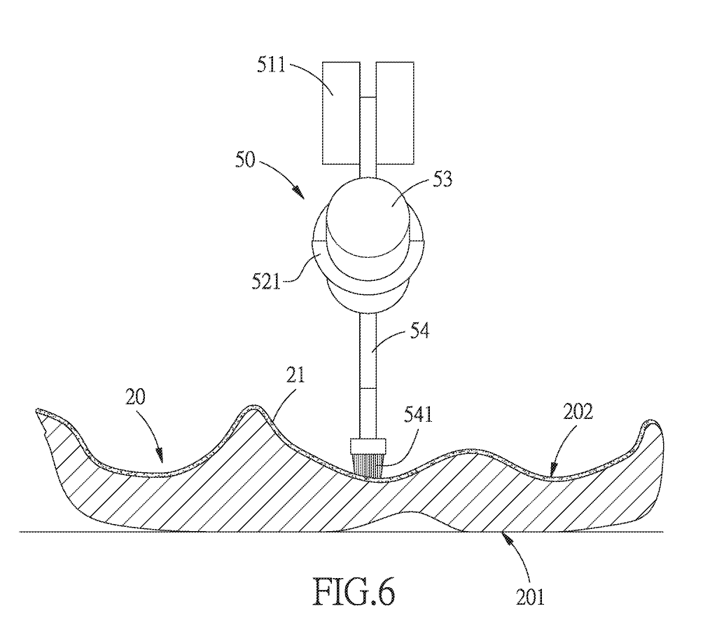

As shown in FIGS. 2 and 6, a spray method for using the automatic spray system for a shoe sole adhesive in accordance with the preferred embodiment of the present invention, comprises the following steps:

a, putting the shoe sole 20 onto the conveyor 30 and conveying it from the starting end 301 to the finishing end 302;

b, scanning, by the three dimensional scanner 40, the top surface 202 of the shoe sole 20, and outputting a scan data of the contour side line 21 of the top surface 202 of the shoe sole 20; in this embodiment, the three dimensional scanner 40 scans the shoe sole 20 which is moving, in a fixed manner;

c, reading, by the computer 60, the scan data;

d, detecting, by the position sensor 31 of the conveyor 30, the position of the shoe sole 20 on the conveyor 30, and outputting a position data corresponding to the scan data obtained by the three dimensional scanner 40, while the three dimensional scanner 40 is scanning;

e, reading, by the computer 60, the position data, and determining, based on the position data, whether or not to send the shoe sole 20 to the adhesive spray section 303 of the conveyor 30, if the shoe sole 20 does not reach the adhesive spray section 303, repeating the previous step d to re-detect the position of the shoe sole 20;

f, when determines that the shoe sole 20 has been sent to the adhesive spray section 303 of the conveyor 30, the computer 60 produces a three dimensional contour data of the contour side line 21 of the shoe sole 20 based on the position data from the position sensor 31 of the conveyor 30 and the scan data from the three dimensional scanner 40, and then creates a movement path instruction for moving the mechanical arm 51, based on the three dimensional contour data and the three dimensional offset from the terminal end 511 of the mechanical arm 51 to the end of the coating portion 541 of the coating tool 54;

g, based on the movement path instruction, the mechanical arm 51 drives the spray gun 53 to move along the contour side line 21 of the top surface 202 of the shoe sole 20 to spray the adhesive A, and the coating portion 541 of the coating tool 54 comes into contact with the coating area 22 of the top surface 202 of the shoe sole 20 and is tangent to the contour side line 21, so that when the mechanical arm 51 drives the coating portion 541 to move along the contour side line 21, the adhesive A which is sprayed by the spray gun 53 and exceeds the contour side line 21 of the shoe sole 20 will be blocked and absorbed by the coating portion 541 of the coating tool 54, and the coating area 22 is coated with the absorbed adhesive A when the coating portion 541 comes into the coating area 22.

To summarize, with the automatic spray system for a shoe sole adhesive and a spray method thereof, the adhesive A can be automatically and precisely (both in position and volume) sprayed in the adhesive spray region 23 of the top surface 202 of the shoe sole 20, and the coating portion 541 of the coating tool 54 can be automatically abutted against the inner side of the contour side line 21 of the shoe sole 20 to block and absorb the redundant adhesive A. Therefore, it can prevent the adhesive A from being sprayed out of the contour side line 21 and prevent excessive adhesive A from influencing the aesthetic appearance of the shoe. Besides, the coating tool 54 comes into contact with the top surface 202 of the shoe sole 20, which allows the adhesive A to be applied evenly to the contour side line 21 of the top surface 202, thus enhancing the adhering strength between the shoe sole and the vamp.

While we have shown and described various embodiments in accordance with the present invention, it is clear to those skilled in the art that further embodiments may be made without departing from the scope of the present invention.

What is claimed is:

1. An automatic spray system for a shoe sole adhesive being used to spray an adhesive onto a shoe sole, the shoe sole including a bottom surface and a top surface, the top surface being concave and provided around a periphery thereof with a three dimensional contour side line which is higher than the top surface, an annular region of an inner surface of the contour side line extending downward from a top edge of the contour side line being defined as a coating area, and another annular region of an inner surface of the contour side line below the coating area being defined as an adhesive spray region, characterized in that the automatic spray system comprises:
a conveyor including a starting end, a finishing end, and an adhesive spray section between the starting and finishing ends, the shoe sole is conveyed from the starting end toward the finishing end, and the conveyor is provided with a position sensor which detects and converts the position of the shoe sole on the conveyor into a position data;
a three dimensional scanner is disposed above the starting end of the conveyor to scan and convert the contour side line of the top surface of the shoe sole into a scan data;
a sprayer includes a mechanical arm, a connecting member, a spray gun and a coating tool, the mechanical arm is located at the adhesive spray section of the conveyor and includes a terminal end which is located above the adhesive spray section, the connecting member is connected to the terminal end of the mechanical arm, and includes two opposite ends, one end is formed with a first assembling portion, and another end is provided with a second assembling portion, the coating tool is assembled to the second assembling portion, the spray gun is disposed on the first assembling portion, and includes a spray nozzle which sprays towards a center of the coating tool, the spray region of the spray gun overlaps with the coating area and the adhesive spray region of the top surface of the shoe sole and slightly exceeds the contour side line, a coating portion of the coating tool comes into contact with the coating area of the top surface of the shoe sole and is tangent to the contour side line;
a computer is electrically connected to the position sensor of the conveyor, the three dimensional scanner and the mechanical arm of the sprayer, to receive the position data and the scan data, based on the received position data and scan data, the computer instructs the mechanical arm to drive the spray gun to move along an inner side of the contour side line of the top surface of the shoe sole to spray adhesive to the coating area and the adhesive spray region, meanwhile, the coating portion of the coating tool is driven to move along the coating area and absorbs the adhesive which exceeds the contour side line.

2. The automatic spray system as claimed in claim 1, wherein the coating area is the annular region of the inner surface of the contour side line extending to 2-3 mm downward from the top edge of the contour side line.

3. The automatic spray system as claimed in claim 1, wherein the coating tool is brushing device, and the coating portion is a brush or sponge.

4. The automatic spray system as claimed in claim 1, wherein the first assembling portion of the connecting member of the sprayer takes the form of a C-shaped structure for clamping the spray gun, and then an adjustment bolt is used to adjust the clamping tightness, the second assembling portion is in the form of a straight rod to be pivoted to the coating tool by an adjustment bolt which is capable of adjusting the position of the spray gun with respect to the coating portion of the coating tool.

5. A spray method for using the automatic spray system as claimed in claim 1, comprising the following steps:
a, putting the shoe sole onto the conveyor and conveying it from the starting end to the finishing end;
b, scanning, by the three dimensional scanner, the contour side line of the top surface of the shoe sole, and outputting a scan data of the contour side line of the top surface of the shoe sole;
c, reading, by the computer, the scan data;
d, detecting, by the position sensor of the conveyor, the position of the shoe sole on the conveyor, and outputting a position data corresponding to the scan data obtained by the three dimensional scanner, while the three dimensional scanner is scanning;
e, reading, by the computer, the position data, and determining, based on the position data, whether or not to send the shoe sole to the adhesive spray section of the conveyor, if the shoe sole does not reach the adhesive spray section, repeating the previous step d to re-detect the position of the shoe sole;
f, determining, by the computer, that the shoe sole has been sent to the adhesive spray section of the conveyor, producing, by the computer, a movement path instruction for moving the mechanical arm, based on the position data and the scan data; and
g, driving, by the mechanical arm, the spray gun to move along the contour side line of the top surface of the shoe sole to spray the adhesive, and the coating portion of the coating tool comes into contact with the coating area of the top surface of the shoe sole and is tangent to the contour side line to block and absorb the adhesive exceeds the contour side line of the shoe sole, and the coating area is coated with the absorbed adhesive when the coating portion comes into the coating area.

6. The spray method as claimed in claim 5, wherein the three dimensional scanner scans the shoe sole which is moving, in a fixed manner.

7. The spray method as claimed in claim 5, wherein the computer produces a three dimensional contour data of the contour side line of the shoe sole based on the position data from the position sensor of the conveyor and the scan data from the three dimensional scanner, and then creates a movement path instruction for moving the mechanical arm, based on the three dimensional contour data and the three dimensional offset from the terminal end of the mechanical arm to the end of the coating portion of the coating tool.

8. The spray method as claimed in claim 5, wherein a spray nozzle sprays towards a center of the coating tool, and the spray region of the spray gun overlaps with the coating area and the adhesive spray region of the top surface of the shoe sole and slightly exceeds the contour side line.
